(19) United States
(12) Patent Application Publication
(10) Pub. No.: US 2024/0272919 A1
(43) Pub. Date: Aug. 15, 2024

(54) Graphical user interface for integrated data analysis

(71) Applicant: Minhong Mi, Newton, MA (US)

(72) Inventor: Minhong Mi, Newton, MA (US)

(21) Appl. No.: 18/622,717

(22) Filed: Mar. 29, 2024

Related U.S. Application Data
(60) Provisional application No. 63/444,894, filed on Feb. 10, 2023.

(51) Int. Cl. G06F 9/451; G06F 3/0482; G06F 3/04845

(52) U.S. Cl. CPC G06F 9/451; G06F 3/0482; G06F 3/04845

(57) ABSTRACT

Method and system are disclosed to implement a graphical user interface (GUI) that unifies key data analysis methodologies—data visualization, spreadsheet operations, and advanced scripting—into a singular, robust platform with a wide range of interactive data widgets and tool widgets. Among the tool widgets, the Workspace Manager widget efficiently organizes user-generated objects in a flexible, hierarchical tree structure, the Environment widget provides a detailed tabular view of variables and datasets with collapsible cell blocks for easy data management, while the Overview widget dynamically presents visual summaries of selected data objects, adapting in real time to user inputs. Additionally, the spreadsheet data widget allows for the direct referencing and assignment of outputs to variables within the active script interpreter's evaluation stacks. By synergistically merging these components, the GUI substantially elevates the data analysis workflow and transforms it into a more integrated and user-friendly process.

### TECHNICAL FIELD

The present invention relates generally to a data analysis tool, and more particularly to a method and system for providing graphical user interfaces that enable a user to analyze data in an integrated environment.

### BACKGROUND

Data analysis software facilitates the development and execution of analytical processes in a user-friendly and efficient manner. In this era of unparalleled data growth and sophistication, the adaptation and expansion of data analysis environments are paramount, while existing software programs are limited to specific analytical methods or steps. For example, some software packages specialize in data visualization, a crucial technique that offers an intuitive means for identifying trends and patterns, transforming abstract numbers into actionable insights through graphical representations; Spreadsheet applications such as Microsoft Excel provide a familiar and versatile platform for data manipulation and calculation, enabling analysts to quickly modify and analyze large datasets; and Integrated Development Environments (IDEs) offer scripting capabilities with the flexibility and power needed to automate repetitive tasks, perform complex analyses, and customize workflows. Bringing together all these methodologies, namely data visualization techniques, spreadsheet functionalities, and advanced scripting capabilities, can lead to one all-encompassing environment that not only enhances the analytical process but also democratizes data analysis, making it accessible and actionable for decision-makers across various disciplines. The importance of such integration cannot be overstated, as it significantly broadens the horizons of what can be achieved in the realm of data analysis, paving the way for innovative solutions to emerge from the rich tapestry of data that defines our world.

In such comprehensive environments, users are expected to create a diverse array of data visualizations, each with varying degrees of detail, while managing significant volumes of data and documents stored across different locations. Furthermore, given the dynamic nature of analytical work, where a user's focus can shift rapidly, the user interfaces within these data analysis platforms must be engineered to instantly present the most appropriate graphical representations and enable efficient management of numerous objects. The ephemeral nature of data visualization demands also highlights the importance of judiciously managing the limited visual space of applications. The challenge lies in preventing the overcrowding of the user's visual field, which can swiftly lead to a sense of overwhelm. As such, efficient screen real estate management is crucial for maintaining usability and enabling users to effortlessly navigate through the process of data verification and analysis.

### SUMMARY

The described embodiment constitutes a methodology and system for implementing a graphical user interface (GUI) for integrated data analysis within a computing environment, aimed at enhancing data analysis process by bringing together all major data analysis methodologies, namely data visualization techniques, spreadsheet functionalities, and advanced scripting capabilities, in a singular, comprehensive platform. This groundbreaking GUI facilitates the creation of and interaction with an extensive array of data widgets. These widgets span a broad spectrum, including, but not limited to, data visualization widgets for graphical data representation, spreadsheet widgets for structured data manipulation, and code editors for executing complex scripts.

A standout feature of this GUI is its inclusion of several innovative tool widgets, including a Workspace Manager widget, an Environment Widget, and an Overview widget. The Workspace Manager widget adeptly parses and organizes information pertaining to all user-generated objects within an adjustable, hierarchical tree format, offering an intuitive and streamlined user experience. Complementing this, the Environment widget presents a detailed view of numerical values, variables, and datasets in a well-ordered, collapsible tabular format, enhancing data accessibility and readability. Furthermore, the Overview widget dynamically adjusts its display to provide a visual summary of the currently focused data object, reflecting changes in real time based on user interactions.

What distinguishes this GUI from conventional interfaces is the synergistic effect of its components. This synergy not only enhances individual data analysis tasks but redefines the overall analytical workflow by integrating diverse functionalities into a unified, user-friendly interface. The detailed description of the patent application further elaborates on how this innovative integration elevates the data analysis process, setting a new standard for data interaction within digital environments.

The summary is provided to introduce a selection of concepts in a simplified form and thus not intended to identify key features or essential features of the claimed subject matter, nor is it intended to be used to limit the scope of the claimed subject matter.

### BRIEF DESCRIPTION OF THE DRAWINGS

FIG. 1 is an illustration of the major components of graphical user interface for integrated data analysis according to this invention;

FIG. 2A is an exemplary screenshot of a spreadsheet widget in accordance with some embodiments of the present invention;

FIG. 2B is an exemplary screenshot of a data visualization widget in accordance with some embodiments of the present invention;

FIG. 2C is an exemplary screenshot of a code editor widget in accordance with some embodiments of the present invention;

FIG. 3 is an exemplary screenshot of the Workspace Manager widget in accordance with the present invention;

FIG. 4 is an exemplary screenshot of the Environment widget in accordance with the present invention;

FIG. 5A through 5J show exemplary screenshots of a graphical user interface that illustrate how the characteristics and functionalities of the Overview widget adjust based on the various active data objects it displays in accordance with the present invention, comprising:

FIG. 5A is a screenshot of the GUI with a spreadsheet widget as the active data object;

FIG. 5B is a screenshot of the GUI with a data table inside a spreadsheet as the active data object;

FIG. 5C is a screenshot of the GUI with a table column as the active data object;

FIG. 5D is a screenshot of the GUI with a data visualization widget as the active data object;

FIG. 5E is a screenshot of the GUI with a chart containing two line graphs as the active data object;

FIG. 5F is a screenshot of the GUI with a chart containing a surface graph as the active data object;

FIG. 5G is a screenshot of the GUI with a code editor widget as the active data object;

FIG. 5H is a screenshot of the GUI with a variable for a vector of numerical values as the active data object;

FIG. 5I is a screenshot of the GUI with a variable cell block for a two-dimensional matrix as the active data object;

FIG. 5J is screenshot of the GUI with an exemplary gallery view in the Overview widget in accordance with the present invention;

FIG. 6 is an exemplary screenshot of the GUI with cell formula in a spreadsheet making reference to part of a numerical variable in accordance with the present invention;

FIG. 7 is an exemplary screenshot of the GUI with the output of a cell formula assigned to a variable and displayed directly inside a spreadsheet using a variable cell in accordance with the present invention;

FIG. 8 illustrates a computing system in which the methodologies in accordance with the present invention may operate;

FIG. 9 illustrates a functional block diagram of an exemplary integrated data analysis environment with a graphical user interface according to this invention; and

FIG. 10 shows a flowchart that outlines the workings of the graphical user interface according to a specific embodiment of the invention.

### DETAILED DESCRIPTION

Embodiments of the present invention advantageously define a graphical user interface (GUI) for integrated data analysis that leverages a broad array of methods and tools, including data visualization techniques, spreadsheet functionalities, and scripting languages, and empowers users to tackle data analysis from varied perspectives. The graphical user interface offers rapid and effective ways to present and manage generated data, ensuring users can quickly comprehend intricate concepts and data sets.

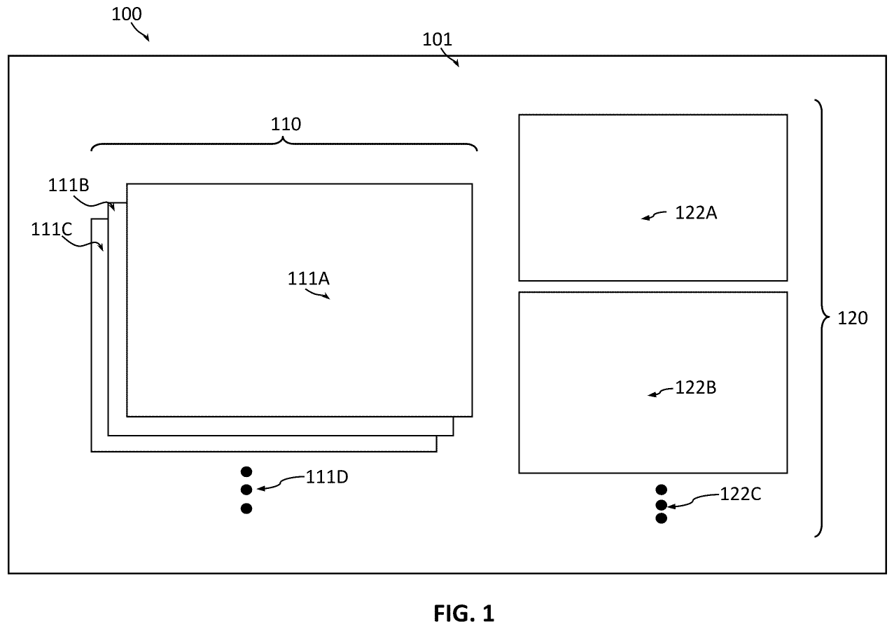

FIG. 1 illustrates an integrated data analysis environment 100 that displays a graphical user interface 101. The graphical user interface 101 features a plurality of data widgets 110 and a plurality of tool widgets 120. These specialized widgets are meticulously designed to cater to the frequent and critical tasks that users undertake, offering support for a wide array of analytical functions. The layout of the data widgets 110 and the tool widgets 120 within the user interface 101 is for purposes of example only. The principles described operate regardless of where the user interface components are laid out, and their precise shape and size. Furthermore, the principles described herein are not limited to providing any particular view on any particular data set. The principles described herein operate just as well regardless of the data widget types being shown, and regardless of the data they represent.

A data widget in a data analysis environment is a user created component that displays the content of specific data sets or document. In one user experience, there may be as few as zero data widgets, all the way up to perhaps very many data widgets as data widgets may be opened and closed in response to events (such as user interaction), and thus the number of available widgets may vary over time. Furthermore, multiple data widgets may be stacked with one or more other data widgets, where only the top data widget is visible. For instance, FIG. 1 illustrates a stacking of data widgets in which the data widget 111A is merely the top of a stack 110 of other data widgets including data widget 111B and 111C. The ellipses 111D represents that this stack may be of any depth and may change dynamically as data widgets are inserted or removed from the stack.

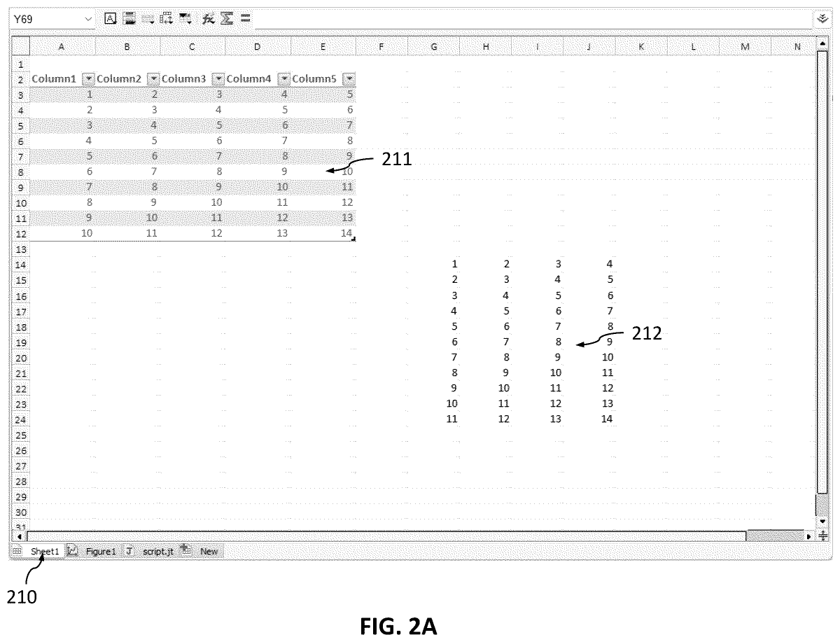

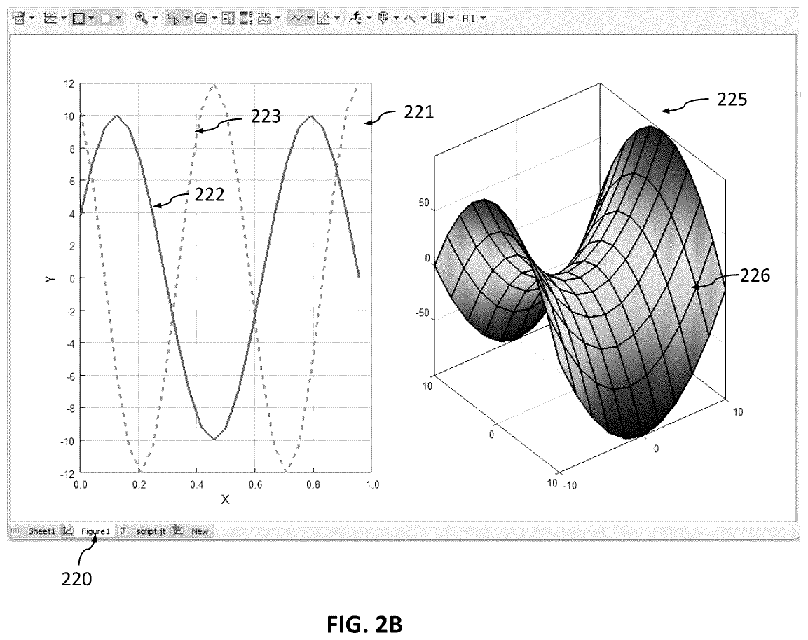

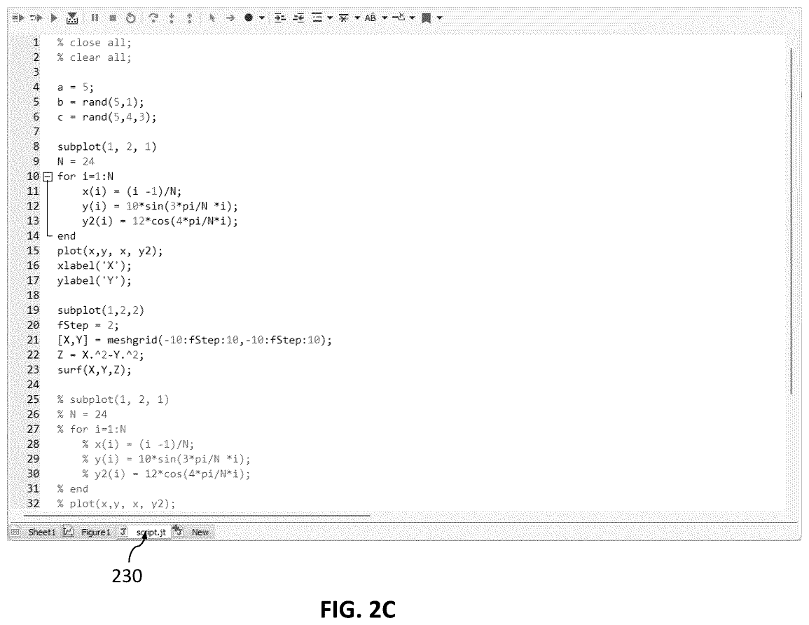

With traditional data analysis tools, the data widgets are usually for the same data or document type. For example, the data widgets are predominantly for spreadsheets in classical Spreadsheet applications or code editors in an IDE. As the graphical user interface according to this invention is designed to support a wide variety of data analysis methods, graphical data visualization sheets, spreadsheets, code editors are equally common, among many others. FIGS. 2A, 2B, and 2C show screen shots of a spreadsheet data widget 210, a graphical visualization data widget 220, and a coded editor widget 230 respectively. The spreadsheet widget 210 includes a data table 211 with five columns and a cell range 212 consisting of four columns. Inside the graphical visualization widget 220 are two charts, chart 221 with two line graphs labeled 222 and 223, and chart 225 with a surface graph 226.

A tool widget in a data analysis environment is a system created component that serves a specific purpose. Tool widgets are single-instance by default, meaning that only one instance of a particular tool widget can be open at a time. After a single-instance tool widget is opened, it remains alive until the whole application program is closed. Closing a single-instance tool widget only changes its visibility. Like data widgets, the number of available tool widgets may vary in one user experience as tool widgets may be opened and closed in response to events. In FIG. 1, two available tool widgets 122A and 122B are explicitly shown while the ellipses 122C indicate that the number of available tools widgets may change dynamically.

In a preferred embodiment of this invention, the graphical user interface may incorporate several familiar tool widgets found in conventional data analysis software and IDE's such as the Command Editor, enabling users to interactively execute commands, and the Properties Pane, which allows for the modification of attributes of selected objects. However, the distinctive feature of this user interface lies in the integration of the Workspace Manager widget, the Environment widget, and the dynamic Overview widget. And, what sets this apart from traditional interfaces is not just these individual components but the unique synergy that emerges from their combined functionality, as elaborated further in the description.

The Workspace Manager widget serves as the pivotal point for managing and organizing all critical aspects of user interaction within the data analysis environment. It presents information about all user created objects, particularly the data widgets mentioned above, in an adjustable tree format, facilitating user exploration into the deeper layers of the object hierarchy to uncover more specific details or subsets of information by expanding designated tree nodes. This hierarchical structure is built on parent-child relationships between objects, where an object is considered subordinate if it acts as a child to another. For example, inside a spreadsheet widget, a data table is categorized as a subsidiary of the spreadsheet, hence lower in the hierarchy, yet it stands above an individual data column within that table in terms of hierarchical positioning. Similarly, within a data visualization widget, objects containing data are organized in a descending hierarchy: sheets, charts, and graphs. Graphs, being the base layer, are essential for depicting comparisons, trends, and relationships in data across a wide variety of predefined types, including scatter plots, line graphs, stem graphs, bar graphs (whether single, stacked, or clustered), surface graphs, matrix plots, and heatmap graphs. Charts function to collate related graphs under a unified set of axes, ensuring coherence among all graphs within a chart. Sheets, acting as the backbone for visual elements, organize multiple charts into a cohesive layout, such as a grid, laying the groundwork for an organized and comprehensive visualization of data.

In contrast to analogous widgets found in more traditional, single-purpose applications, the Workspace Manager widget in an integrated data analysis environment accommodates a broader spectrum of object types, paralleling the diversity of data widgets available. More importantly, for objects lacking explicit parent-child delineations, the software ingeniously analyzes and infers hierarchical relationships to streamline organization and management. For example, while cells within a table in a spreadsheet naturally follow a hierarchical order from column to table to sheet, solitary cells outside of tables defy simple categorization. Directly placing such individual cells under the sheet in the Workspace Manager widget would quickly overwhelm users as cell counts escalate. To address this, the software employs geometric analysis algorithms to identify contiguous cell ranges, grouping them under the sheet node, thereby allowing for an organized hierarchy that logically extends from column to cell range, to sheet. Moreover, the program not only ensures correspondence between data objects and tree nodes in the Workspace Manager widget, but also seamless integration of selection actions in the Workspace Manager widget with their real-time visual counterparts to provide a unified user experience.

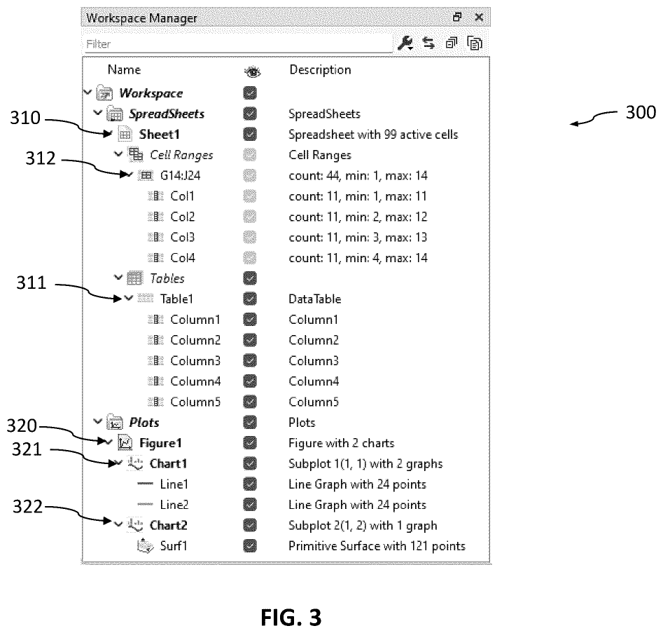

FIG. 3 displays a screenshot of the Workspace Manager widget 300, as described in this patent, showing its display during a session with two distinct data widgets, previously illustrated in FIGS. 2A and 2B, being active. Within the Workspace Manager widget, the spreadsheet widget 210 from FIG. 2A is symbolized by a tree node labeled 310. Beneath this spreadsheet node 310, two subsidiary nodes, 311 and 312, denote table 211 and cell range 212 found within the spreadsheet. Below the node 311 for table 211, there are five additional nodes, each representing one of the table columns. Similarly, under the node 312 for cell range 212, four nodes are present, each corresponding to one of the columns within the cell range 212. The tree structure within the Workspace Manager widget also includes node 320 for the data visualization widget 220 in FIG. 2B, and nodes 331 and 332 representing charts 221 and 222, respectively.

The Environment widget according to this invention offers a comprehensive display of variables, data sets, and functions within the active command interpreter's evaluation stack. It enhances the traditional icon and tree views common to similar widgets in many data analysis applications by incorporating a feature to display detailed numerical values of these items in a tabular arrangement using ordered cell blocks. Like a spreadsheet table, a cell block represents a rectangular area of related cells that can be managed and referenced independently from other parts of the environment. However, unlike spreadsheet tables that stand as separate data entities, cell blocks within the Environment widget serve primarily as a means to visualize data from items such as variables, without possessing unique identifiers. They are identifiable only through the names of the data they display. Consequently, any changes to the values of these variables are directly reflected in the cell block displays. It should be noted that variable cell blocks may appear not only in the Environment widget, but users can also drag and drop variable cell blocks into a spreadsheet data widget, or even create them directly in spreadsheets as described later.

When displaying variable contents using cell blocks, scalar values such as integers and floats are shown adjacent to their names in the header row, while more complex data types like arrays, lists, and data frames are summarized in the header with details accessible through an expansion button. This button reveals the data's numerical values organized in rows or columns, presented in a style that is either automatically determined or specified by the user. For some complex data types such as high dimensional arrays, a variable cell block may also contain one or more child blocks inside its body. Furthermore, users can choose to show descriptive statistics and sparklines for numerical values of each column as column headers for any variables that have more than one row of numerical values. They can also apply table styles to achieve desired visual appearance with choices encompassing not only common table styles with banded rows or columns, but also innovative options that enable encoding the numerical values for cell background or text foreground colors to provide quick and straightforward visualization of the values.

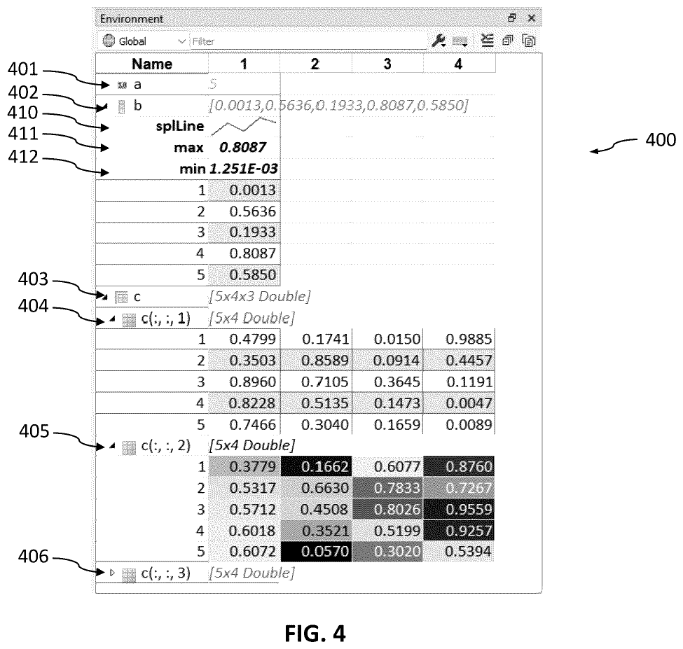

FIG. 4. displays a screenshot of the Environment widget 400, as described in this patent, showing the variables in the evaluation stack of an active command interpreter. Among them, variable “a” is a scalar integer whose value is shown right next to the header cell of cell block 401, variable “b” is a vector of floating numbers represented by cell block 402 with a single column of data cells, and variable “c” is a 5×4×3 array of float values represented by cell block 403 with three child blocks 404, 405, and 406 (collapsed) that each represent the values in a 5×4 two-dimensional matrix. A sparkline 410 and two descriptive statistics, labeled 411 and 412, are included on top of the data column of cell block 402 to illustrate the feature. The cell block 404 has a style with banded rows while the cell block 405 is assigned a style that color coded the cell background with the cell value.

Frequent users of data analysis applications will appreciate the ease of examining and adjusting variables, thanks to the presentation of precise numerical values directly within the cell block bodies of the Environment widget. Additionally, the software facilitates the creation of data visualizations straight from the data items selected within the widget, automatically linking the visualizations to their data sources by default. This feature significantly simplifies the process of data visualization and ensures a highly synchronized interaction between managing data visualizations and their underlying data sources.

The Overview widget, as described in this invention, is engineered to provide a visual synopsis of a data containing object. The data containing objects that may be visualized in the Overview widget encompass a broad range, from the previously mentioned data widgets to specific elements within data or tool widgets, including but not limited to data tables, data columns, charts, graphs, variables, and links to external data sources. The program dynamically determines the focus data object based on recent user interactions, and instantly refreshes the Overview widget to showcase the most relevant data of the focus data object, enabling the widget's visual display to adapt quickly to changes initiated by the user.

By default, when user interacts with objects inside any data widgets directly, the system prioritizes the display of data objects that are situated lower in the data visualization hierarchy mentioned earlier to ensure relevance. For example, selecting a cell within a data table leads to the display of the data table, rather than the spreadsheet in its entirety. Likewise, engaging with a specific chart among several within a data visualization widget (or sheet) triggers a focused display of that chart in the Overview widget, reflecting its status as a lower hierarchical child of the data visualization sheet. Conversely, when user clicks any tree node in the Workspace Manager widget, visual representation of the object associated with the tree node is shown in the Overview widget. If the object is too low in the visualization hierarchy, like a dividual graph in a chart, graphical representation of its closest parent object in the hierarchy, meaning the containing chart in the case of a graph, is shown.

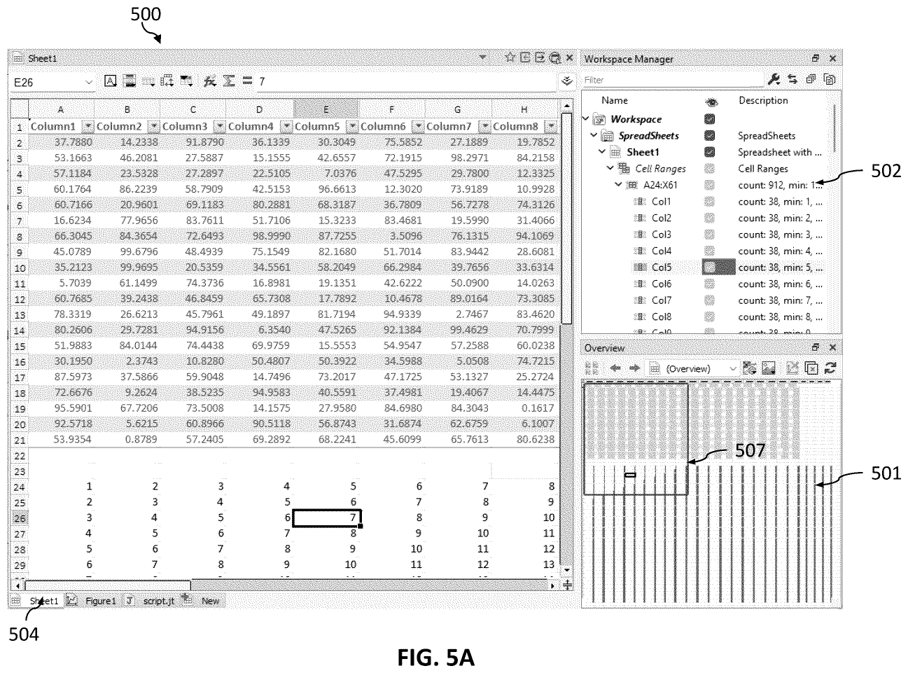

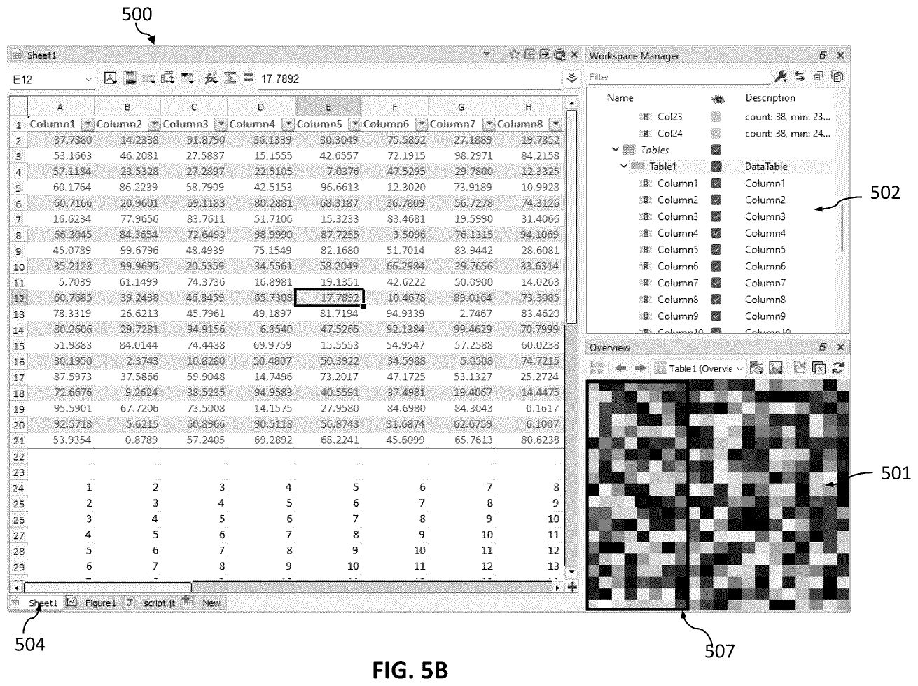

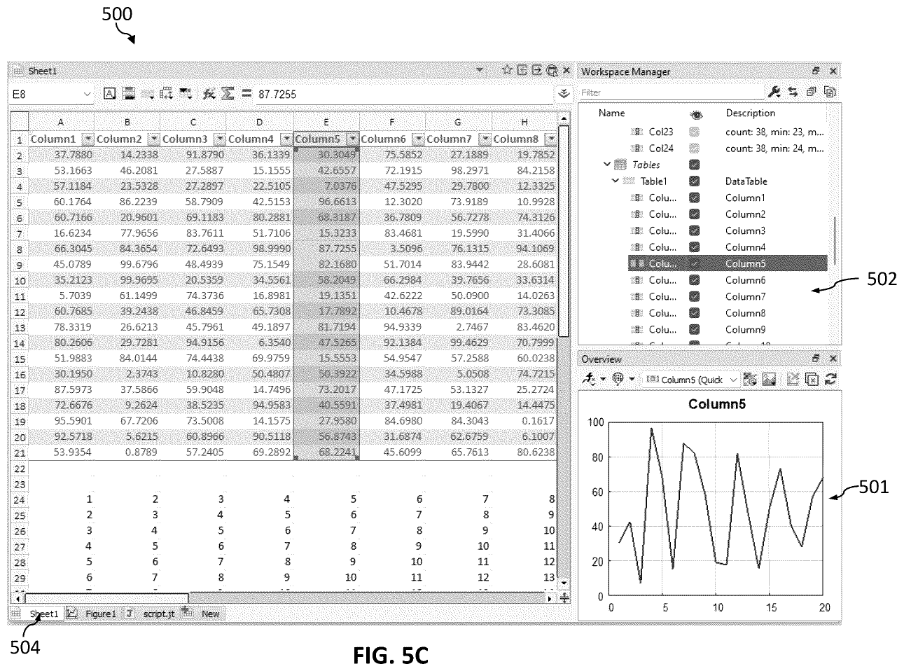

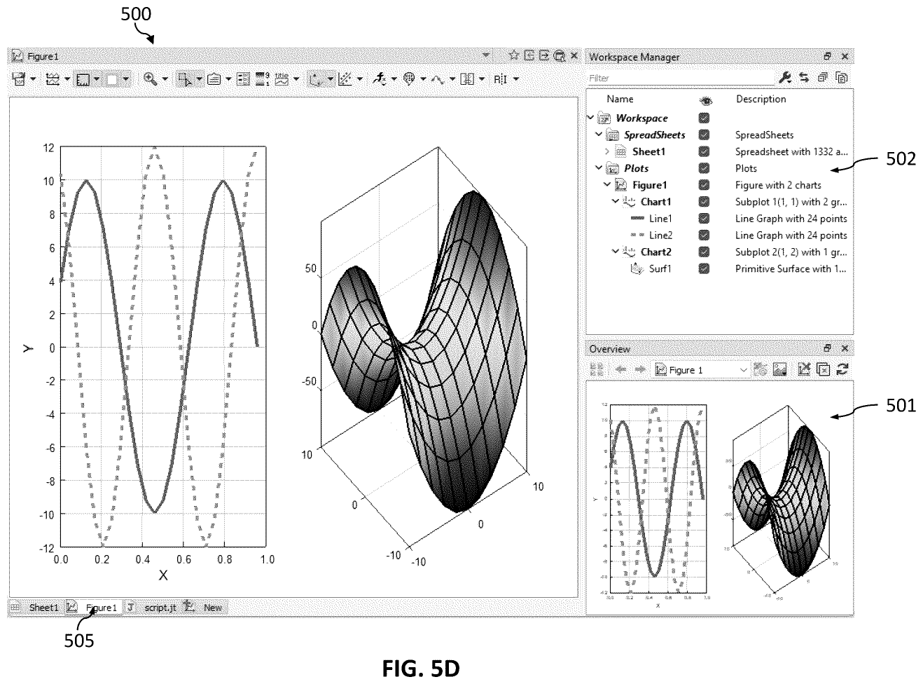

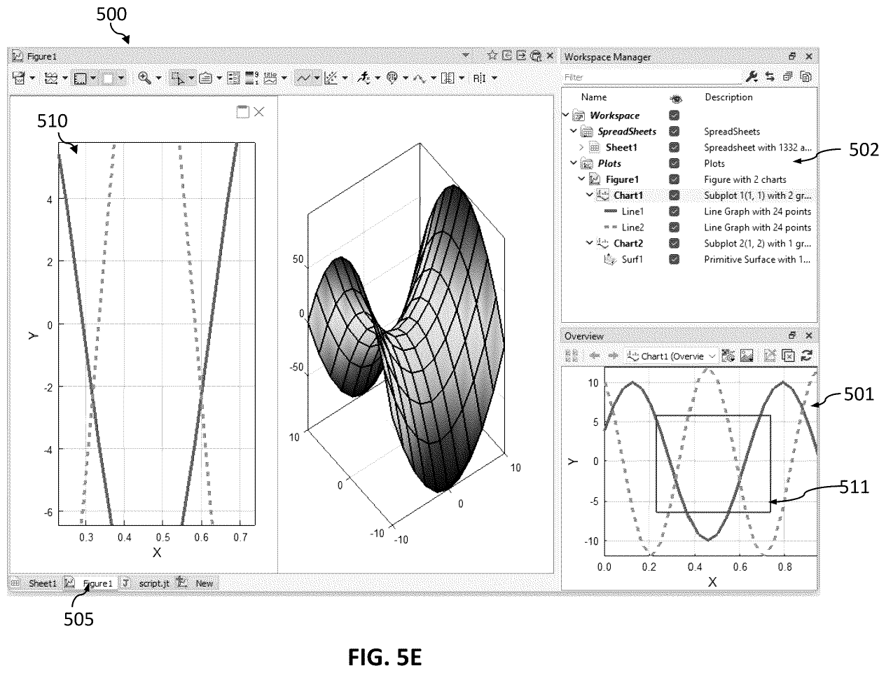

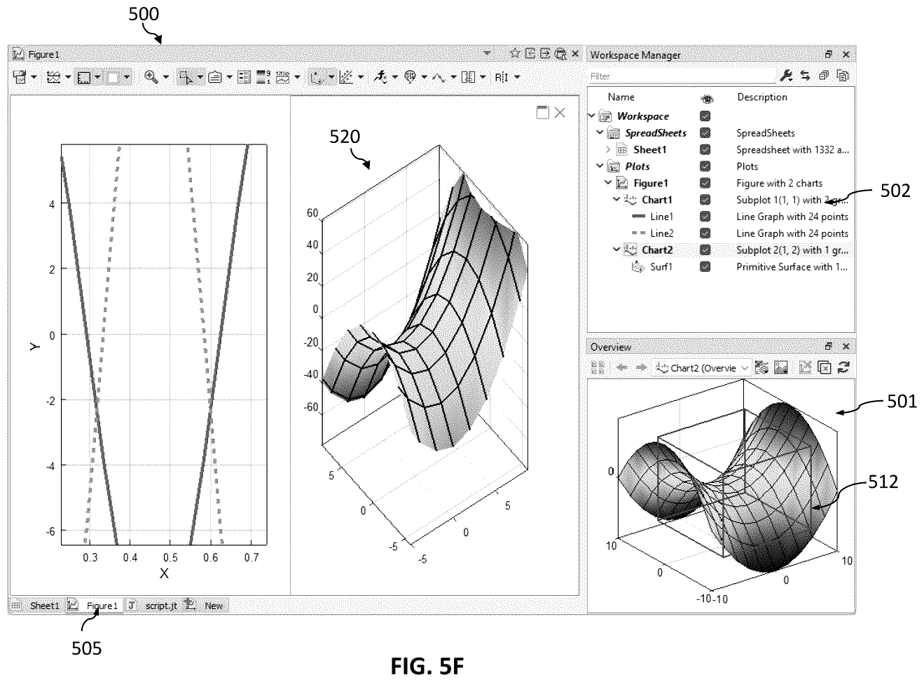

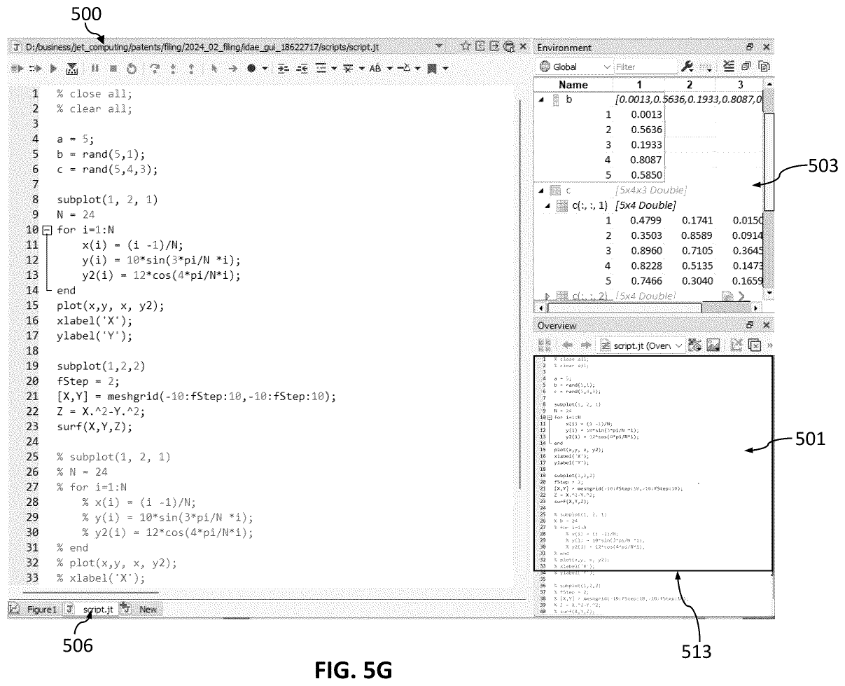

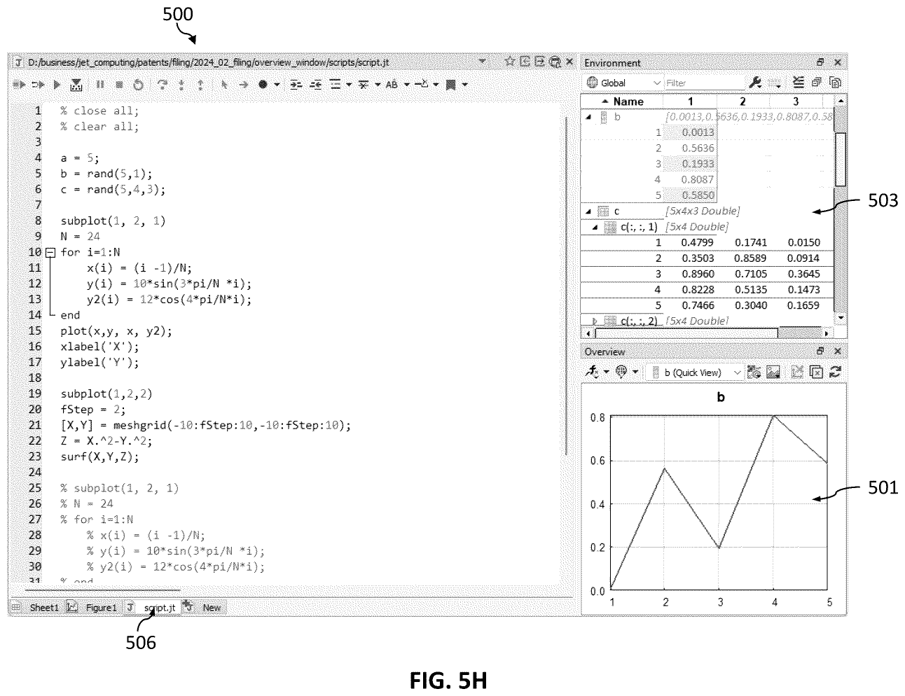

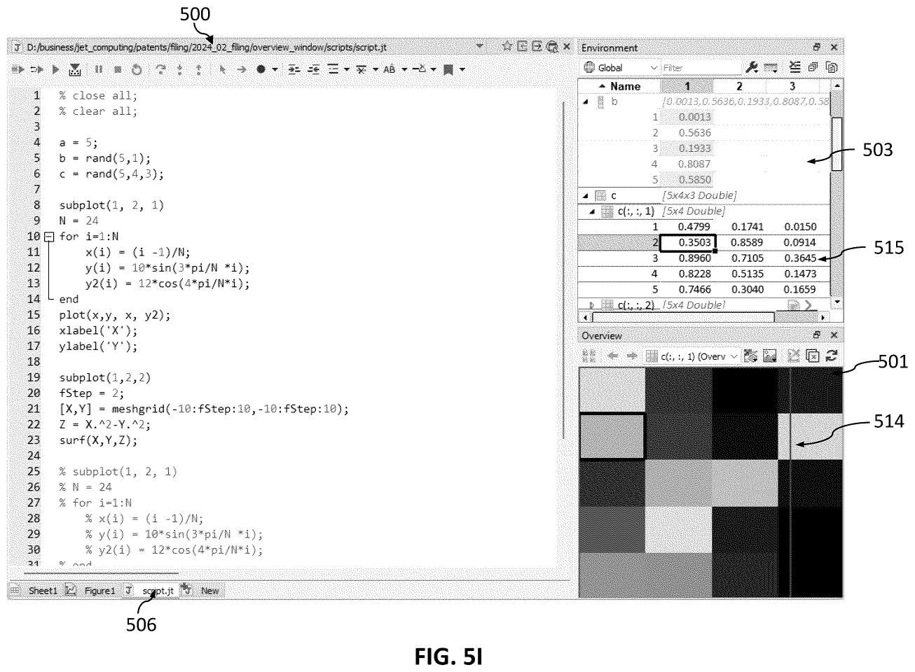

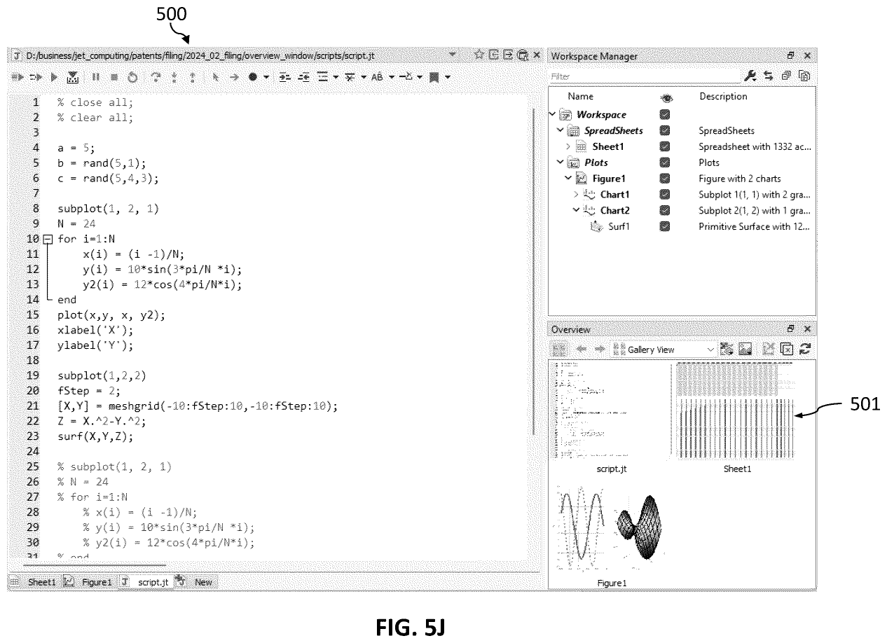

In the subsequent sections, detailed examples of user interfaces are presented in relation to FIG. 5A through FIG. 5J, where the characteristics and functionalities of the Overview widget adjust based on the various active data objects it displays. These examples will illustrate how the widget's appearance and behavior are tailored to reflect the specific types of data currently being interacted with, showcasing the widget's versatility and adaptability in different data analysis contexts.

FIGS. 5A, 5B, and 5C present various aspects of a user interface, denoted as 500, featuring an Overview widget 501 and a Workspace Manager widget 502. Within this interface, three data widgets, numbered 504 to 506, are open, with the spreadsheet data widget 504 positioned at the forefront of the data widget display stack, thereby becoming the primary point of user engagement. Like the spreadsheet depicted in FIG. 2A, spreadsheet 504 is equipped with a data table and a continuous range of cells. However, in contrast to the spreadsheet 210, this version boasts a significantly larger number of columns in both its data table and cell range, enhancing the visibility of the invention's features. In this arrangement, selecting a specific cell, such as E26 in the spreadsheet, prompts the Overview widget 501 to refresh and provide a comprehensive visual summary of all cells, regardless of their visibility in the current view of the spreadsheet. FIG. 5A demonstrates this with cells represented as small rectangles, and text depicted by filled rectangles when the text characters are too diminutive for individual display. Conversely, FIG. 5B shows the user interface 500 with a focus on a data table within the spreadsheet 504, triggered by selecting a cell E12 within the table or its corresponding node in the Workspace Manager widget 502. Here, the Overview widget employs a heatmap to depict the data table values within a color-coded grid. In both cases, a dynamic rectangle 507 marks the area of cells currently in view, enabling view adjustments through dragging. FIG. 5C captures the user interface 500 with a table column as the focal point, initiated by selecting the column's header cell or its related tree node in the Workspace Manager widget 502, where the column's numerical data is displayed as a line graph in the Overview widget. While FIG. 5B and FIG. 5C focus on the displays with a data table and table column as focal points to demonstrate the Overview widget's adaptable functionality, it is noted that similar dynamics apply to scenarios involving the cell range and any columns within it as focus objects. In these instances, cell range values are depicted through a heatmap, and values in any column within the cell range are visualized using a line graph, showcasing the flexible and responsive design of the Overview widget.

FIGS. 5D, 5E, and 5F depict the same user interface 500 as described above but with a graphical data visualization widget 505 being on top of the data widget stack. The graphical data visualization widget 505 contains the same two charts as the graphical data visualization widget 220 in FIG. 2B. With it being the primary point of interest, the Overview widget provides an all-encompassing view in FIG. 5D, while FIG. 5E displays the interface with a specific chart, labeled 510, as the focal point. Here, some of the chart's data points are outside the visible frame, possibly because of zooming actions, but the Overview widget adjusts its axes to ensure all data points are included in the view. It uses a rectangular marker 511 to highlight the section of the chart that is currently visible. Similarly, FIG. 5F demonstrates the interface with a different chart, denoted as 520, being the central focus. A wireframe box 521 indicates the range of values that are currently visible in chart 520.

FIGS. 5G, 5H, and 5I present different views of the same user interface 500 configured for scripting in data analysis tasks, where the Environment widget 503, instead of the Workspace Manager 502 is visible, and a code editor 506 is on the top of the data widget display stack. With the code editor 506 being the focal point (active data object), the Overview widget 501 provides a comprehensive snapshot of all code present in FIG. 5G, highlighting the portion of text currently in view with a dynamic rectangle 513. In contrast, selecting any variable from the Environment widget 503 triggers the Overview widget to display a detailed graphical representation of the variable that is designed for maximum clarity and ease of comprehension as illustrated in FIGS. 5H and 5I. In FIG. 5H, the same variable “b” of a vector of numerical data mentioned earlier is depicted through a line graph in the Overview widget, while a two-dimensional matrix slice of the variable “c” is visualized via a heatmap graph in FIG. 5I. Like the heatmap in FIG. 5B, a rectangular marker 514 is shown on top of the heatmap to indicate the visible cell ranges in the tabular display of values in the corresponding variable cell block 515 inside the Environment widget 503, enabling view adjustments through dragging.

As demonstrated through the above-described examples, the Overview widget automatically refreshes its display in response to user interactions by default. However, the program also allows users to manually select the summary visualization to be displayed in the Overview widget. Specifically, it further offers a special option for displaying a “Gallery” view like the one shown in FIG. 5J, where every open data widget is represented by a small image. And, upon user actions such as double clicking on any of the icons, the corresponding data widget is activated and the display inside the Overview widget is switched to its visual summary automatically.

The integration of the widgets described earlier, and their seamless interaction significantly streamline and improve the performance of common data analysis activities, such as exploratory data analysis and data mining. Furthermore, the integration of the previously separate technologies creates opportunities for enhancing or broadening their application. An example of such enhancement, detailed below, includes the fusion of traditional spreadsheet technologies with scripting capabilities.

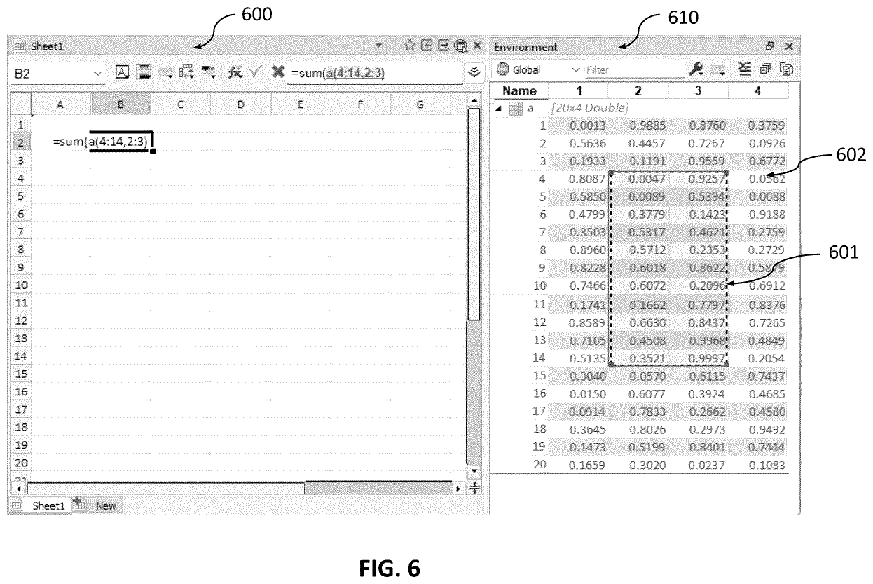

Traditional spreadsheet applications like Microsoft Excel enable users to compute and update cell values dynamically using formulas. These formulas, which usually begin with an “=” symbol, can incorporate constants, cell references, named ranges, and built-in functions. The application recalculates the values of these formulas automatically whenever any referenced data changes. The integrated data analysis environment according to this invention extends the capabilities of conventional spreadsheet formulas, supporting not only cell range, table, and named references within formulas but also allowing them to access variables from the evaluation stacks of the active script interpreter. For instance, if a variable “x” with a value of 5 exists in the interpreter's global evaluation stack, inputting “=x+3” into a cell will result in the cell displaying a value of 8 upon execution. Furthermore, like cell ranges can be selected interactively as referenced data in a formula, partial or full reference to a variable in the evaluation stack can also be made interactively with its corresponding cell block in the Environment widget or any containing spreadsheet. FIG. 6 illustrates an instance where the “sum” function in the formula for cell B2 of a spreadsheet 600 takes elements of a two-dimensional matrix variable “a” as its input. This partial reference to the variable is indicated by a rectangular marker 601 inside the variable cell block 602 in the Environment widget 610. User can adjust the referenced variable element range by dragging the marker 601. And just like changes in cell values lead to automatic formula recalculation, modifications to the referenced values in a scripting variable cause the formula to recalculate its output automatically as well.

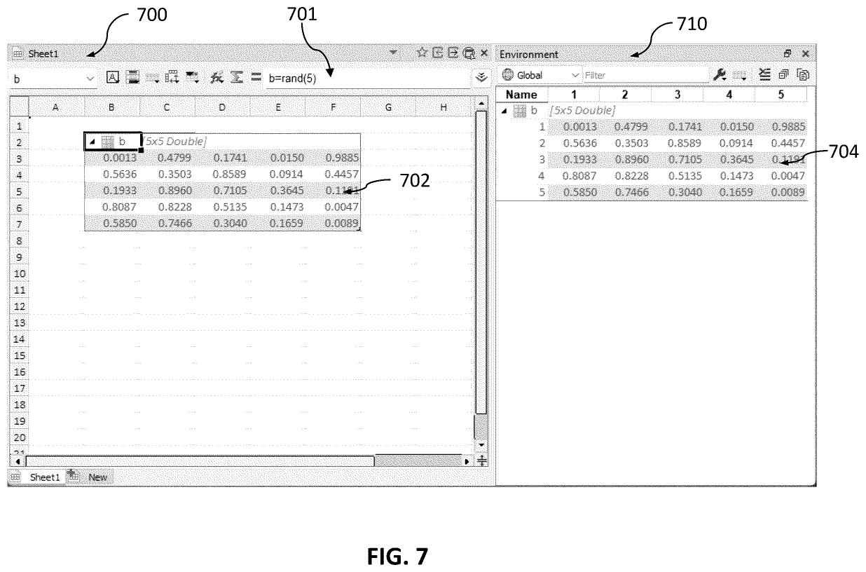

Furthermore, with existing spreadsheet programs, formula outputs are confined to cells, the integrated data analysis environment according to this invention permits outputs to be directed to variables, displaying them within a movable and collapsible cell block in the spreadsheet. For example, as illustrated in FIG. 7 with a spreadsheet 700, entering “b=rand(5)” into the formula bar 701 with B2 as the target cell, and evaluating the function not only computes the value but also visually represents a new variable “b” for a 5×5 matrix of random numbers created by the function “rand(5)” in a cell block 702 spanning B2:F7. Inputting assignment statements into spreadsheet mirrors their entry in the Command Editor, with the addition that variable cell blocks are automatically generated or updated within the spreadsheet. These variables are then accessible through the interpreter's evaluation stack, treated equivalently to other variables. As such, a variable cell 704 is simultaneously added to the Environment widget 710.

Additionally, the integrated data analysis environment may also enable the use of the scripting language's built-in functions with cell ranges and data tables directly in formulas, similarly to how standard spreadsheet functions are used. This greatly enhances the power of the integrated spreadsheet program as it opens doors to a much richer collection of functions and libraries than the limited library of functions usually shipped with an existing spreadsheet program.

The above-described functionalities effectively transform spreadsheets into an interactive shell or REPL (read-eval-print loop), allowing users to execute commands in any cell and view results in a table-like format directly. Since variable cell blocks are merely visual representations and do not consume worksheet storage, users can efficiently manage numerous variables and extensive data within the same spreadsheet with minimal overhead.

Detailing each component individually and through static imagery above may not entirely capture the dynamic and fleeting aspects of user interactions. To bridge this gap, the subsequent section is dedicated to illustrating the interface's benefits in a live context, by going through a typical analytical workflow. This narrative will highlight various functionalities as the user progresses through each step of a data analysis task, providing a vivid demonstration of the interface's comprehensive capabilities and its potential to streamline and enrich the data analysis experience.

Within the graphical user interface according to this invention, initiating a data analysis task may involve the user employing a code editor widget to script, import relevant data sets, conduct cleaning operations, and store the results in various variables. The Environment widget immediately updates to display a list of these variable names. When user clicks on the expansion button next to one of the variables, especially one representing a complex two-dimensional array full of rows and columns, all its values are shown in a neatly organized cell block directly below, complete with descriptive statistics atop each column for quick reference. Concurrently, a summary visualization of the variable, likely a heatmap, appears in the Overview widget, allowing easy recognition of patterns or abnormalities in the values. Should detailed examination of specific data points is warranted, the user can adjust the Overview widget's rectangular range marker to highlight the desired cells in the Environment widget's variable cell block. Switching the data's graphical representation is as straightforward as selecting an option from the Overview widget's dropdown menu. As users navigate through different variable names, the Environment and Overview widgets update in real time, enabling swift evaluation of the data's quality and main features—key for comprehensive exploratory data analysis and data mining. As the analysis continues into deeper data exploration, modeling, and reporting phases, users may generate various data widgets with extensive graphical visualizations in multiple manners, including selecting data from the Environment widget, double-clicking graphs in the Overview widget, and executing further scripts. The Workspace Manager and Overview widgets are invaluable for managing and monitoring the plethora of these visualization objects. Users can also integrate spreadsheet widgets to organize data from ad-hoc sources and employ formulas for generating values that summarize or represent other data and variables. This setup facilitates effortless scenario analysis, with such values being dynamically recalibrated as the underlying data or variables are easily modified.

Having described the visual and functional aspects of the graphical user interface. The discussion now turns to the operational mechanics.

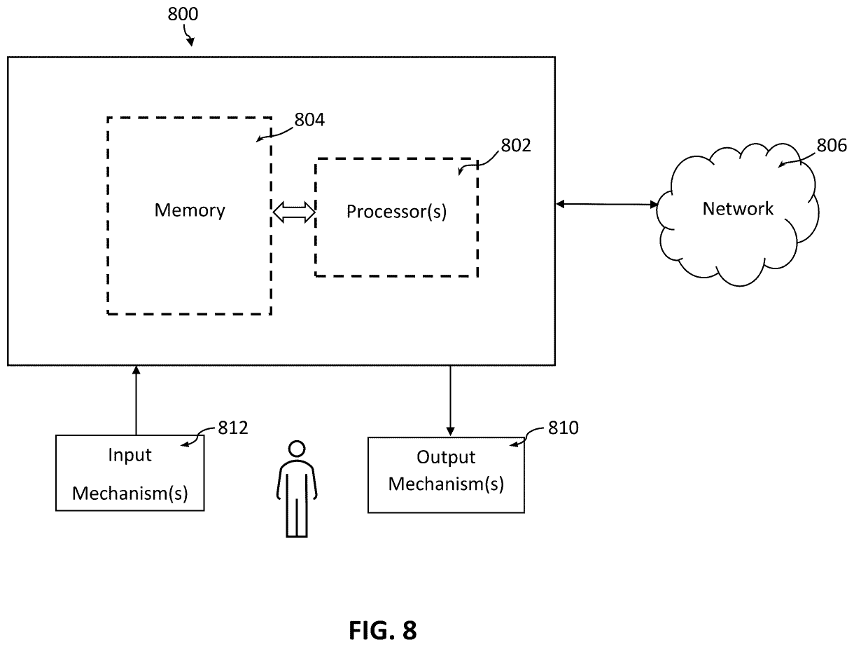

The provision of the graphical user interface for integrated data analysis is facilitated by a computing system 800 as illustrated in FIG. 8, which is inclusively defined to encompass any device or amalgamation of devices equipped with at least one physical, tangible processor 802 and a corresponding physical, tangible memory 804. This memory 804, capable of storing executable instructions for the processor, may vary in form based on the computing system's design and purpose. Notably, the computing infrastructure can span across networked environments 806 incorporating multiple interconnected systems. Furthermore, the computing system 800 may include both output mechanisms 810 and input mechanisms 812. Output mechanism 810 could range from speakers and screens to more advanced options like holograms and virtual reality. Similarly, input mechanisms 812 may cover a wide spectrum, from microphones and touchscreens to various sensors and physical controls, adapting to the specific needs and functionalities of the computing system.

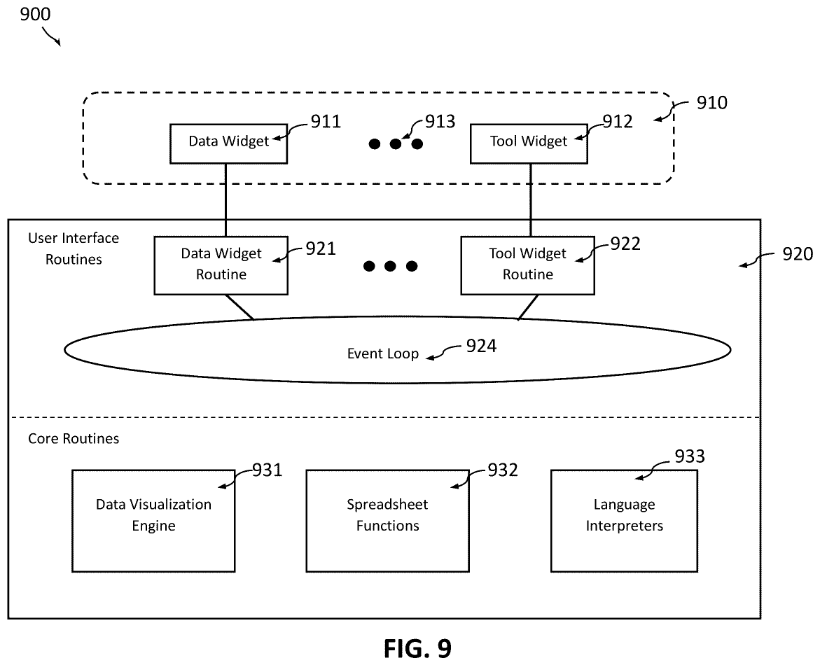

FIG. 9 illustrates a functional block diagram of an exemplary integrated data analysis environment 900 with a graphical user interface according to this invention. The environment includes computing device 920 and display device 910. Display device 910 may be used to display the graphical user interface with a plurality of both data widgets 911 and tool widgets 912, as indicated by the ellipsis 913. If the data analysis environment 900 were operated with the computing system 800 of FIG. 8, the display might use, for example, one of the output mechanisms 810 described above and the computing device 920 is generally equivalent to the rest of the computing system, viewed from a software programming perspective.

In various embodiments, the computing device 920 may allow users to make selections, enter texts, move a cursor, and drag and drop widgets using one of the input mechanisms 808. The computing device 920 generally provides Application Programming Interfaces (API's) to allow programs running on the computing device to obtain information from the input mechanisms whenever a click or touch, or keyboard hit, hereinafter “event”, occurs. Data widget 911 and tool widget 912 events may be recognized when a mouse pointer or touch has entered, touched, clicked, dragged, dropped, moved, or left the area of the display device 910 covered by the data widget 911 or tool widget 912, and when a key has been hit on a keyboard.

The computing device 920 stores computer-executable instructions for user interface and core routines in tangible memory 804. The user interface routines include one or more data widget routines, one for each data widget, and one or more tool widget routines, one for each tool widget type. The core function routines include but are not limited to the data visualization engine 931, the spreadsheet functions 932, and the language interpreters 933. In addition, the computing device 920 actively maintains an event loop 924, which serves as the central mechanism for managing and responding to user actions and system events. Operating continuously while the application is active, the event loop listens for events such as keystrokes, mouse clicks, or system-generated notifications. Upon detecting an event, it dispatches this information to the appropriate component, such as the data widget routine 921 and the tool widget routine 922, for handling.

While processing events, interface routines may invoke core routines for a range of background tasks, including but not limited to data management, graphical rendering, formula computations, and complex numerical analysis, occasionally triggering further events necessitating additional handling. For example, a mouse click on a spreadsheet cell within the GUI's display is identified as an event by the system, subsequently managed by the event loop 924. The loop initially assigns this event to the pertinent data widget routine for the spreadsheet, which marks the selected cell. Subsequently, the event is relayed to both the Workspace Manager widget and the Overview widget routines, provided these tool widgets are active. The Workspace Manager routine then highlights the corresponding element in its interface, whereas the Overview routine examines the data of the selected column, table, or cell range, engaging the data visualization engine to generate a suitable visual representation. This systematic approach to event handling ensures a cohesive and responsive user experience, facilitating seamless interaction with the graphical user interface.

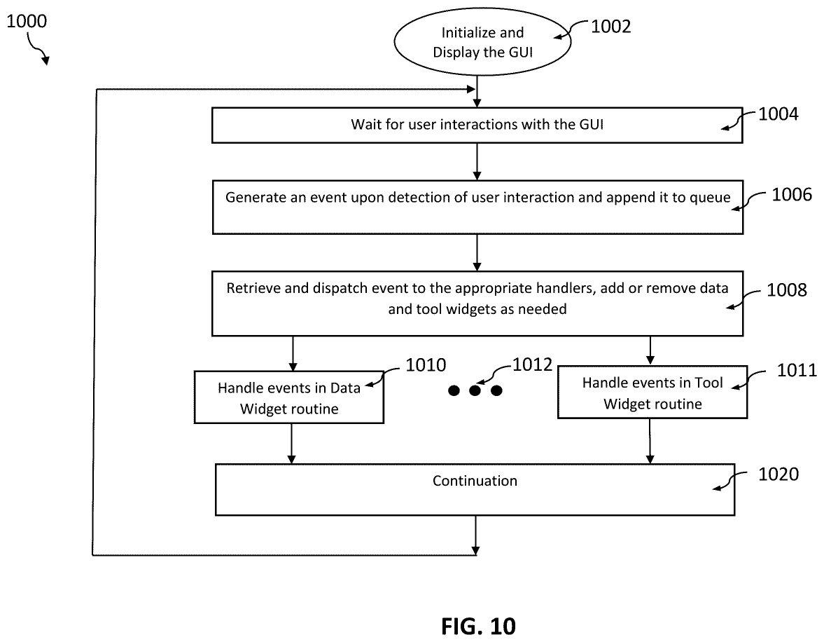

FIG. 10 presents flowchart 1000, which outlines the workings of the integrated data analysis interface according to a specific embodiment of the invention. At the onset of the data analysis application, the computing device 920 initiates by launching and displaying the graphical user interface, replete with an assortment of tool widgets, menus, buttons, and other standard interface components, as denoted by Block 1002. Following this initialization, the application transitions into the infinite event loop 924, poised to detect and respond to user inputs within the GUI, a process encapsulated by Block 1004. Any form of user interaction, be it mouse movement, button clicks, or other engagements with the GUI, prompts the creation of an event, which is then enqueued within the event loop as depicted by Block 1006. This method ensures the application remains operational and responsive, deferring event processing to a suitable moment. Block 1008 details how the event loop sequentially fetches and processes events from the queue, consulting a predefined mapping or similar structure to identify and delegate each event to its corresponding handler based on the event's nature. Specific triggers, such as selecting an option to insert a new data visualization, initiate actions like adding or removing widgets within the interface. The handlers, illustrated through Blocks 1010, 1011, and further suggested by ellipsis 1012, activate to execute necessary responses to each event. These responses could range from enlarging the detail display in the Environment widget, refreshing data visualizations in the Overview widget, to adjusting spreadsheet views. Block 1020 signifies the event loop's return to its monitoring state post-event handling, perpetuating this operational cycle for the duration of the application's activity. In scenarios where the event queue is empty, the loop may momentarily pause, optimizing resource consumption until the next user interaction occurs.

The methodologies disclosed in this invention are executable across various computing systems, guided by software-driven processes. These processes entail the execution of computer-readable instructions by one or more processors, thereby orchestrating the computing system's operations, including data manipulation. Such instructions are typically housed on computer-readable media, forming the basis of a computer program product.

Experts in the field will recognize the invention's compatibility with a broad spectrum of computing system configurations. These range from personal to mainframe computers, including portable devices, multi-processor systems, consumer electronics, network PCs, and even emerging technologies like wearables. The invention is equally applicable in distributed computing setups, where tasks are allocated across both proximal and distal computing entities interconnected via a mix of wired and wireless networks, with software modules distributed across local and remote storage devices.

Furthermore, the invention is adeptly suited for implementation within cloud computing environments, characterized by the dynamic allocation of computing resources over a network. This model supports various operational characteristics (like on-demand self-service and rapid elasticity) and service models, including SaaS, PaaS, and IaaS, across different deployment models such as private, public, and hybrid clouds. In essence, the description and claims encompass the employment of cloud computing as an integral environment for the invention's application.

While the content discussed has been detailed using terminology specific to computer structure, methods, and computer-readable formats, it should be noted that the invention outlined in the claims attached is not confined to the particular details mentioned. Instead, these details are provided as illustrative examples of how the claims might be realized.

The subject matter outlined above is intended purely for illustrative purposes and should not be seen as restrictive. It is possible to apply various alterations and modifications to the described content without straying from the example embodiments and applications presented, and without deviating from the genuine essence and breadth of the current invention, as delineated in the subsequent claims.

What is claimed is:

1. A method executed by a computer system for operating a graphical user interface (GUI) for integrated data analysis, the method comprising:
displaying a plurality of data widgets alongside a plurality of tool widgets on a computer system's display;
receiving user input through various interaction mechanisms with the GUI, including direct manipulation of widgets (such as dragging, dropping, resizing), gesture inputs, voice commands, and traditional input methods (keyboard and mouse actions); and
dynamically and instantaneously updating the display of the said data and tool widgets in response to the user inputs.

2. The method of claim 1, wherein the plurality of data widgets comprises:
a plurality of data visualization widgets that graphically represent datasets, enabling users to visually analyze and interpret complex information through charts, graphs, and other visual representations;
a plurality of spreadsheet widgets that display and manage tabular data, allowing users to interact with, manipulate, and analyze information within a grid format, complete with functionalities for formula calculations, data sorting, and formatting; and
a plurality of code editors that allow users to display, edit, and manage code, offering syntax highlighting, line numbering, and other features to facilitate coding tasks.

3. The method of claim 2, wherein the plurality of tool widgets comprises:
a tool widget, hereto referred to as the Workspace Manager widget, that presents information about all user created objects, particularly the said data widgets, in an adjustable hierarchical tree format, and serves as the pivotal point for managing and organizing all critical aspects of user interaction within the data analysis environment;
a tool widget, hereto referred to as the Environment widget, that offers a comprehensive display of variables, data sets, and functions within the active command interpreter's evaluation stack; and
a tool widget, hereto referred to as the Overview widget, that provides a visual synopsis of a data containing object inside a data or tool widget, hereto referred to as the main widget.

4. The method of claim 3, wherein the Workspace Manager widget enables identification and logical grouping of contiguous cell ranges within spreadsheet widgets, organizing them in a hierarchical structure from column to cell range to sheet, enhancing data structure visibility and accessibility.

5. The method of claim 3, wherein the Environment widget features presentation of variables and datasets in a structured tabular arrangement using ordered collapsable cell blocks, hereto referred as variable cell blocks, enabling detailed examination and manipulation of data values.

6. The method of claim 5, wherein the variable cell blocks:
may encompass nested child cell blocks for detailed hierarchical data representation;
are configurable to exhibit descriptive statistics and sparklines in column headers, offering immediate data insights; and
include styling options that visually encode data values through color schemes applied to cell backgrounds or text, enhancing data readability and user engagement.

7. The method of claim 3, wherein the Overview widget dynamically updates to:
reflect user interactions with data widgets and the Workspace Manager, showcasing summary visualizations of the currently focused data object, thereby facilitating quick graphical visualization of the most relevant data;
display graphical visualizations of data contained within variable cell blocks interacted with in the Environment widget, providing immediate visual data insights;
indicate the visible data range in the main widget with a resizable rectangular or wireframe marker, allowing users to adjust data display ranges through direct interaction; and
offer a gallery view of icons representing open data widgets, where user actions such as double-clicking an icon activate the corresponding widget, streamlining navigation and widget management.

8. The method of claim 3, wherein spreadsheet widget cell formulas can dynamically reference partial or full values from variables within the active script interpreter's evaluation stack, facilitated by user-driven adjustments in the Environment widget.

9. The method of claim 3, wherein outputs from spreadsheet widget cell formulas can be directly assigned to variables in the script interpreter's evaluation stack, with the assigned values prominently displayed within variable cell blocks in the spreadsheet, bridging the gap between spreadsheet calculations and script-based data analysis.

10. A computer system comprising:
a processor; and
a computer-readable storage medium having computer-executable instructions stored thereon which, when executed by a computer, cause the apparatus to perform operations comprising:
displaying a plurality of data widgets alongside a plurality of tool widgets on a computer system's display;
receiving user input through various interaction mechanisms with the GUI, including direct manipulation of widgets (such as dragging, dropping, resizing), gesture inputs, voice commands, and traditional input methods (keyboard and mouse actions); and
dynamically and instantaneously updating the display of the said data and tool widgets in response to the user inputs.

11. The computer system of claim 10, wherein the plurality of data widgets comprises:
a plurality of data visualization widgets that graphically represent datasets, enabling users to visually analyze and interpret complex information through charts, graphs, and other visual representations;
a plurality of spreadsheet widgets that display and manage tabular data, allowing users to interact with, manipulate, and analyze information within a grid format, complete with functionalities for formula calculations, data sorting, and formatting; and
a plurality of code editors that allow users to display, edit, and manage code, offering syntax highlighting, line numbering, and other features to facilitate coding tasks.

12. The computer system of claim 11, wherein the plurality of tool widgets comprises:
a tool widget, hereto referred to as the Workspace Manager widget, that presents information about all user created objects, particularly the said data widgets, in an adjustable hierarchical tree format, and serves as the pivotal point for managing and organizing all critical aspects of user interaction within the data analysis environment;
a tool widget, hereto referred to as the Environment widget, that offers a comprehensive display of variables, data sets, and functions within the active command interpreter's evaluation stack; and
a tool widget, hereto referred to as the Overview widget, that provides a visual synopsis of a data containing object inside a data or tool widget, hereto referred to as the main widget.

13. The computer system of claim 12, wherein the Workspace Manager widget enables identification and logical grouping of contiguous cell ranges within spreadsheet widgets, organizing them in a hierarchical structure from column to cell range to sheet, enhancing data structure visibility and accessibility.

14. The computer system of claim 12, wherein the Environment widget features presentation of variables and datasets in a structured tabular arrangement using ordered collapsable cell blocks, hereto referred as variable cell blocks, enabling detailed examination and manipulation of data values.

15. The computer system of claim 14, wherein the variable cell blocks:
may encompass nested child cell blocks for detailed hierarchical data representation;
are configurable to exhibit descriptive statistics and sparklines in column headers, offering immediate data insights; and
include styling options that visually encode data values through color schemes applied to cell backgrounds or text, enhancing data readability and user engagement.

16. The computer system of claim 12, wherein the Overview widget dynamically updates to:
reflect user interactions with data widgets and the Workspace Manager, showcasing summary visualizations of the currently focused data object, thereby facilitating quick graphical visualization of the most relevant data;
display graphical visualizations of data contained within variable cell blocks interacted with in the Environment widget, providing immediate visual data insights;
indicate the visible data range in the main widget with a resizable rectangular or wireframe marker, allowing users to adjust data display ranges through direct interaction; and
offer a gallery view of icons representing open data widgets, where user actions such as double-clicking an icon activate the corresponding widget, streamlining navigation and widget management.

17. The computer system of claim 12, wherein spreadsheet widget cell formulas can dynamically reference partial or full values from variables within the active script interpreter's evaluation stack, facilitated by user-driven adjustments in the Environment widget.

18. The computer system of claim 12, wherein outputs from spreadsheet widget cell formulas can be directly assigned to variables in the script interpreter's evaluation stack, with the assigned values prominently displayed within variable cell blocks in the spreadsheet, bridging the gap between spreadsheet calculations and script-based data analysis.
